(19) United States
(12) Patent Application Publication
(10) Pub. No.: US 2026/0244545 A1
(43) Pub. Date: Aug. 20, 2026

(54) SYSTEMS AND METHODS FOR TESTING VIRTUAL MACHINE SYSTEMS FOR ERRORS

(71) Applicant: Samsung Electronics Co., Ltd., Suwon-si (KR)

(72) Inventors: Yuchen Zhou, West Lafayette, IN (US); Tong Zhang, Fremont, CA (US); Da Zhang, Fremont, CA (US); Rekha Pitchumani, Oak Hill, VA (US); Yang Seok Ki, Palo Alto, CA (US)

(21) Appl. No.: 19/244,837

(22) Filed: Jun. 20, 2025

Related U.S. Application Data
(60) Provisional application No. 63/760,403, filed on Feb. 19, 2025.

(51) Int. Cl. G06F 11/26; G06F 9/455

(52) U.S. Cl. CPC G06F 11/26; G06F 9/45558

(57) ABSTRACT

Systems and methods for testing virtual machine systems for errors are disclosed. A processor receives a command to perform a test. The command includes a memory range associated with a virtual device accessible by a virtual machine. Based on the command, a second instruction is generated. The second instruction identifies a first operation and a memory address selected from the memory range. Status of the first operation is detected based on the virtual device performing the first operation. An output is generated based on the status.

### CROSS-REFERENCE TO RELATED APPLICATION(S)

The present application claims priority to and the benefit of U.S. Provisional Application No. 63/760,403, filed Feb. 19, 2025, entitled “SYSTEM AND METHOD FOR FINDING BUGS IN HARDWARE OR HYPERVISORS,” the entire content of which is incorporated herein by reference.

### FIELD

One or more aspects of embodiments according to the present disclosure relate to virtual machine systems, and more particularly to systems and methods for testing virtual machine systems for errors.

### BACKGROUND

Computing environments such as data centers may use virtual machines (VMs) to allow multiple users to share resources of a physical machine. In some cases, a virtual machine monitor or virtualizer (e.g., a hypervisor) may manage and allocate the resources of the physical machine to the VMs. The hypervisor may be implemented using software that may be attacked by a malicious VM.

The above information disclosed in this Background section is only for enhancement of understanding of the background of the present disclosure, and therefore, it may contain information that does not form prior art.

### SUMMARY

Embodiments of the present disclosure are directed to a system comprising a processor and a memory. The memory includes first instructions that, when executed by the processor, cause the processor to: receive a command to perform a test, wherein the command includes a memory range associated with a virtual device accessible by a virtual machine; based on the command, generate a second instruction, wherein the second instruction identifies a first operation and a memory address selected from the memory range; detect status of the first operation based on the virtual device performing the first operation; and generate an output based on the status.

In some embodiments, the instructions that cause the processor to detect status of the first operation include instructions that cause the processor to detect an error in processing the first operation.

In some embodiments, the first instructions further cause the processor to generate a file including the second instruction; generate machine-readable code based on the file; provide the machine-readable code to the virtual machine, wherein the virtual machine is configured to transmit the second instruction based on executing the machine-readable code.

In some embodiments, the first operation includes a memory access operation.

In some embodiments, the second instruction includes a value, wherein the first instructions cause the processor to generate the value.

In some embodiments, the first instructions cause the processor to select the first operation from a list of operations identified by the processor.

In some embodiments, the first instructions cause the processor to randomly select the first operation from the list of operations.

In some embodiments, the first instructions cause the processor to: identify a profile associated with the list of operations; and select the first operation based on the profile.

In some embodiments, the first instructions cause the processor to: identify a frequency of performing the first operation; and select the first operation based on the frequency.

In some embodiments, the frequency of performing the first operation is less than a frequency of performing a second operation of the list of operations.

One or more embodiments of the present disclosure are also directed to a method that includes: receiving, by a processor, a command to perform a test, wherein the command includes a memory range associated with a virtual device accessible by a virtual machine; based on the command, generating, by the processor, an instruction, wherein the instruction identifies a first operation and a memory address selected from the memory range; detecting, by the processor, status of the first operation based on the virtual device performing the first operation; and generating, by the processor, an output based on the status.

These and other features, aspects and advantages of the embodiments of the present disclosure will be more fully understood when considered with respect to the following detailed description, appended claims, and accompanying drawings. Of course, the actual scope of the invention is defined by the appended claims.

### BRIEF DESCRIPTION OF THE DRAWINGS

Non-limiting and non-exhaustive embodiments of the present embodiments are described with reference to the following figures, wherein like reference numerals refer to like parts throughout the various views unless otherwise specified.

FIG. 1 depicts a block diagram of a virtual machine system according to one or more embodiments;

FIG. 2 depicts a block diagram of a testing tool according to one or more embodiments;

FIG. 3 depicts a conceptual diagram of a fuzzy testing instruction generated by a code generator according to one or more embodiments;

FIG. 4 depicts a flow diagram of a process for fuzzy testing a virtual machine system for errors according to one or more embodiments; and

FIG. 5 depicts a flow diagram of an interaction between a virtual machine and a virtual machine monitor based on the virtual machine executing a fuzzy testing code according to one or more embodiments.

### DETAILED DESCRIPTION

Hereinafter, example embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, descriptions thereof may not be repeated. Further, in the drawings, the relative sizes of elements, layers, and regions may be exaggerated and/or simplified for clarity.

Embodiments of the present disclosure are described below with reference to block diagrams and flow diagrams. Thus, it should be understood that each block of the block diagrams and flow diagrams may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (for example the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flow diagrams. Accordingly, the block diagrams and flow diagrams support various combinations of embodiments for performing the specified instructions, operations, or steps.

In addition, a feature of embodiments of the present disclosure may be combined or combined with one or more other features, partially or entirely, and may be operated in various ways, and an embodiment may be implemented independently of one or more other embodiments, or in conjunction with the one or more other embodiments.

Data centers, cloud computing environments, and/or other computing environments may use one or more VMs to allow one or more users (also referred to as tenants) to run one or more programs and operating systems on a physical machine (referred to as a host computing device). A VM monitor (e.g., a hypervisor) may partition the host machine into multiple VMs to provide service to the tenants. The VM monitor may be susceptible to bugs, errors, or other vulnerabilities. A malicious tenant may exploit such vulnerabilities to gain access to the VM monitor to compromise security and functionality of the tenants that use the VMs, and take control of the host machine or crash the host machine.

In general terms, embodiments of the present disclosure are directed to systems and methods for testing a VM monitor for errors. In some embodiments, a testing tool is invoked to test one or more virtual devices established by the VM monitor as well as emulation of an instruction set architecture (ISA) that interfaces with the one or more virtual devices. The testing tool (also referred to as a fuzzing tool) may use random, pseudorandom, invalid, and/or unexpected input (referred to as “fuzz”) to test the one or more virtual devices together with the ISA. The testing tool may generate a command to perform the test. The command may identify an operation to be performed by the virtual device, and a parameter of the operation. The parameter may include a fuzz value.

In some embodiments, the fuzz that is provided to a memory address of the virtual device is included as an operand of an instruction that is processed by an ISA emulator. In this manner, any errors that may occur in the translation process may be detected in addition to any errors of the virtual device in processing the fuzz provided to the memory address of the virtual device.

In some embodiments, the testing tool is configured to receive a command to initiate the fuzzy testing of the VM monitor. The command may include identification of a memory address associated or mapped to a virtual device that is to be tested. The testing tool may generate one or more instructions to test one or more memory addresses mapped to the virtual device. The one or more instructions may be for interacting with the virtual device at the one or more memory addresses.

In some embodiments, the testing tool may identify an operation to be performed by the virtual device, and one or more parameters of the operation. The one or more parameters may include, for example, a fuzz (e.g., random, pseudorandom, invalid, etc.) value. For example, if the virtual device is a storage device, and the operation is a write operation, the testing tool may identify an operation identifier for the write operation, a memory address of the storage device where the write is to be performed, and a fuzz value (e.g., random data) to be written to the memory address. The write operation may be transmitted to the VM monitor for processing. The testing tool may detect whether processing of the operation results in errors.

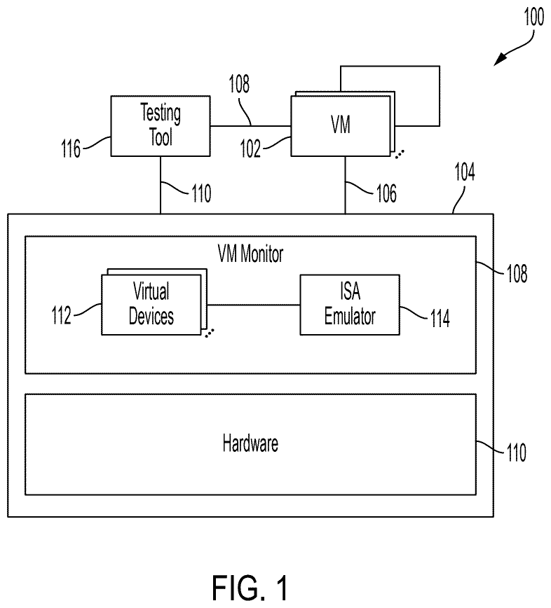

FIG. 1 depicts a block diagram of a VM system 100 according to one or more embodiments. The VM system may include one or more VMs 102 coupled to a host computing device (also referred to as a host) 104 over a data communications link 106. The data communications link 106 may include a local area network, private wide area network, and/or the public Internet. In some embodiments, the VMs are associated respectively with different tenants. The tenants may use the VMs to run one or more programs and operating systems using the physical resources of the host 104. In this regard, the data and operating system run by one VM may be isolated from the data and operating system run by another VM.

The host 104 may include a VM monitor 108 and physical hardware components 110. The physical hardware components 110 may include, for example, a processor, memory, storage devices, display devices, timers, microphone, speakers, graphics cards, controllers (e.g., advanced programmable interrupt controller (APIC), network interfaces (e.g., Small Computer System Interface (SCSI), network interface card (NIC), peripheral component interconnect express (PCIe), serial advanced technology attachment (SATA), etc.), and/or the like. In some embodiments, the memory of the host 104 includes instructions that cause the processor to implement the management and allocation of resources by the VM monitor 108.

In some embodiments, the VM monitor 108 may partition resources of the host 104 into multiple VMs 102 to provide service to the tenants. In this regard, the VM monitor 108 is configured to manage and allocate the physical hardware components 110 for use by the VMs 102 to run their respective operating systems and programs. The VM monitor 102 may be implemented via software, firmware, hardware, or a combination of software, firmware, and/or hardware. For example, the VM monitor 102 may be implemented via a central processing unit (CPU) configured to execute instructions stored in memory. The CPU and memory may be part of the host's physical hardware components 110.

In some embodiments, the VM monitor 102 includes one or more virtual devices 112 and an ISA emulator 114. The virtual devices 112 may be software-based representations of one or more of the physical hardware components 110 of the host 104. In this regard, the virtual devices 112 may be implemented as a software layer that sits between the physical hardware components 110 and applications running on the VMs 102. The virtual devices 112 may be configured to emulate or simulate the corresponding physical device via software. In this regard, the virtual devices 112 may be configured to receive (e.g., indirectly receive) input requests from the applications and direct the input requests to the appropriate physical hardware devices 110. The physical hardware devices 110 may provide, to the virtual devices 112, outputs corresponding to the input requests, and the virtual devices 112 may transmit the outputs to the requesting VMs 102.

In some embodiments, the virtual devices 112 are assigned (e.g., memory-mapped) to memory addresses of the memory of the host 104. The ISA emulator 114 may interact with the virtual devices at the assigned memory addresses, to perform the operations requested by the applications in the transmitted input requests. In this regard, the ISA emulator 114 may intercept the input requests from the applications, and translate the input requests into instructions that the virtual devices 112 may process to simulate the requested interactions with the corresponding physical devices.

In some embodiments, the input request includes a command directed to the virtual device's memory-mapped I/O (MMIO) address. In some embodiments, the command includes an identification of an operation (referred to as an “opcode”) and one or more operands. A first operand may include the address to which the virtual device has been mapped. A second operand may include a value associated with the operation. For example, if the operation is a “write” operation, the first operand may identify the address of the virtual storage device to where data is to be written, and the second operand may include the actual data that is to be written.

In some cases, the software of the VM monitor 108 may be susceptible to bugs, errors, or other vulnerabilities. A malicious tenant may exploit such vulnerabilities to gain access to the VM monitor 108 to compromise security and functionality of the tenants that use the VMs 102, and take control of the host machine or crash the host machine.

In some embodiments, the VM system 100 includes a testing tool 116 configured to perform fuzz testing of one or more of the virtual devices 112 together with the fuzz testing of the ISA emulator 114, to detect an attack by a malicious tenant or to identify other bugs or errors. The testing tool 116 may be implemented via software, firmware, hardware, or a combination of software, firmware, and/or hardware. For example, the testing tool 116 may include a processor and a memory. The memory may store instructions that, when executed by the processor, cause the processor to implement the fuzz testing described herein.

In some embodiments, the testing tool 116 is coupled to the VM 102 and the host 104 over a data communications network 108, 110. The data communications network 108, 110 may include a local area network, private wide area network, and/or the public Internet. In some embodiments, the testing tool 116 is a stand-alone device. In some embodiments, the testing tool 116 forms part of the VM 102.

The testing tool 116 may be configured to receive a command or request to initiate fuzzy testing of one or more virtual devices 112. The testing tool 116 may generate one or more fuzzy testing instructions in response to the command. A fuzzy testing instruction may include, for example, at least one fuzz value to be provided to a memory address of the virtual device. The testing instruction may be configured to perform fuzzy testing of the virtual device 112 along with the testing of the ISA emulator 114 which is invoked to translate the instruction for interacting with the virtual device.

In some embodiments, the generated testing instructions are stored in a file and converted to a binary or assembly code (collectively referenced as machine-readable code) for execution by the VM 102. Execution of the machine-readable code may cause the VM 102 to transmit the testing instructions (e.g., the machine-readable instructions) to the VM monitor 108. The VM monitor 108 may invoke the ISA emulator 114 to translate the received instructions (e, g., first instructions) into translated instructions (e.g., second instructions) suitable for the virtual device 112.

The virtual device 112 may process the translated instructions from the ISA emulator 114 and emulate operation of the corresponding physical hardware component 110 using software. In this regard, the virtual device 112 may interact with the corresponding physical hardware component 110 to carry out the requested operation based on the fuzz value. The virtual device 112 may receive an output from the physical hardware component 110 in response to the operation. In this manner, the virtual device 112 and ISA emulator 114 may be tested together for errors. The errors may be due to faulty translation by the ISA emulator 114 and/or due to error of the virtual device 112 in emulating the operation of the corresponding physical hardware component 110 using the fuzz value.

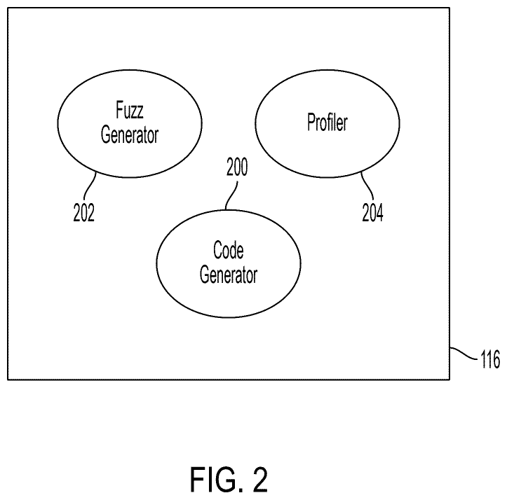

FIG. 2 depicts a block diagram of the testing tool 116 according to one or more embodiments. The testing tool 116 includes, without limitation, a code generator 200, fuzz generator 202, and profiler 204. The code generator 200, fuzz generator 202, and profiler 204 may be implemented via hardware, firmware (e.g., via an ASIC) and/or via a processor of the testing tool 116 configured to execute instructions stored in memory. Although the code generator 200, fuzz generator 202, and profiler 204 are assumed to be separate functional units, a person of skill in the art will recognize that the functionality of these components may be combined or integrated into a single component, or further subdivided into further sub-components without departing from the spirit and scope of the inventive concept.

In some embodiments, the code generator 200 is configured to receive a command or request to initiate testing of one or more VM monitors 102. The command may be provided, for example, by a user accessing the testing tool 116. The command may include a memory address of the virtual device 112 to be accessed. For example, if a virtual device 112 is mapped to the host memory starting at memory location 381000004000, and has a size of 16k, the following command may be invoked to test the virtual device:
./fuzz_test 0x381000004000 x=0x4000

In some embodiments, the code generator 200 generates one or more fuzzy testing instructions in response to the command. The generated testing instructions may be stored in a human-readable text file, and converted or compiled into a binary or assembly code for execution by the VM 102.

A testing instruction may include, for example, an opcode of an operation to be tested, and one or more parameters or operands of the operation. In some embodiments, the code generator 200 selects the opcode from a list (e.g., a preset list) of available opcodes associated with the ISA. The operands may depend on the identified opcodes. For example, a write operation may be associated with a memory address and value operands. The memory address may be selected (e.g., randomly) from the range of memory addresses mapped to the virtual device 112 that is to be tested. The value operand may be a fuzz (e.g., random) value generated by the fuzz generator 202.

In some embodiments, the code generator 200 selects the opcodes from the list of available opcodes on a random basis. In some embodiments, the opcodes are selected according to a profile. The profile may relate to the list of operations associated with the ISA. For example, the profile may indicate a frequency in which the operations are used by an operating system. In some embodiments, the code generator 200 may choose operations that are less frequently used (e.g., operations with a frequency below a threshold frequency), for testing. By using the profile of the ISA for guiding the fuzzy testing, less frequently reached paths or operations may be tested to identify vulnerabilities in the VM monitor.

In some embodiments, the profile is generated by the profiler 204. In this regard, the profiler 204 may take, as input, executable files of an operating system stored in a storage device, and perform analysis of the opcodes in the executable files. The analysis may include determining a frequency in which the opcodes are invoked in the executable files. The profiler 204 may generate a distribution of the frequencies for the opcodes, and store the distribution in a profile for the ISA.

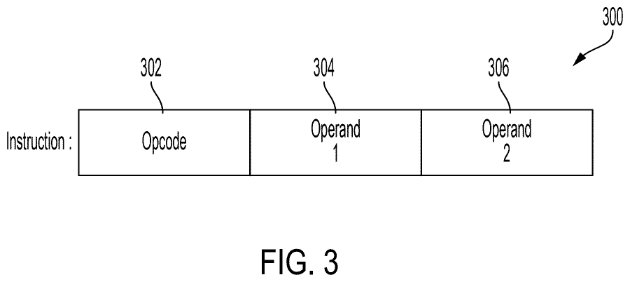

FIG. 3 depicts a conceptual diagram of a fuzzy testing instruction 300 generated by the code generator 200 according to one or more embodiments. The instruction 300 includes an opcode 302, a first operand 304, and a second operand 306, although embodiments are not limited thereto. For example, some opcodes may need more or less operands than two.

The opcode 302 may be a value identifying the operation to be performed. Example operations may include read, write, fetch, move, load, set context, and/or the like.

The first operand may be a memory address selected from the range of memory addresses associated with the virtual device 112. The memory address may be selected randomly, sequentially, according to a pattern, and/or the like.

The second operand 306 may include a fuzz value generated by the fuzz generator 202. For example, the fuzz value may be a random value, a pseudorandom value, invalid value, and/or the like. For example, the fuzz value may be random data to be written to the virtual device 112, an address of a register, and/or other data associated with the identified operation.

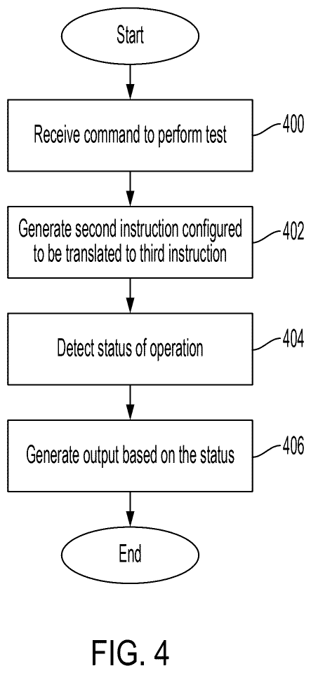

FIG. 4 depicts a flow diagram of a process for fuzzy testing a VM system for errors according to one or more embodiments. In act 400, the testing tool 116 receives a command to perform a test. The command may include a memory range mapped to a virtual device 112 accessible to a VM 102. The VM 102 may be created by computer code (e.g., a hypervisor) executed on a physical device (e.g., the host 104). The computer code may provide the virtual device 112 for access by the VM 102.

In act 402, based on the command, the testing tool 116 is configured to generate a second instruction (e.g., a fuzzy testing instruction) for testing the virtual device 112 to perform a first operation. The second instruction may identify the first operation and a memory address selected from the memory range that is mapped to the virtual device.

In some embodiments, the first operation includes a memory access operation (e.g., read, write, load, move, etc.). The first operation may be selected from a list of operations identified by the processor. In some embodiments, the first operation is selected randomly. In some embodiments, the processor identifies a profile associated with the list of operations, and selects the first operation based on the profile. The profile may identify a frequency of the first operation. The frequency of the first operation may be less than a frequency of a second operation of the list of operations.

In some embodiments, the second instruction includes a value (e.g., a fuzz value) that may be generated via random generation. The value may be used to perform the first operation identified in the second instruction.

The second instruction may be configured to be translated (e.g., by the ISA emulator 114) into a third instruction (e.g., a translated instruction), and provided to the virtual device 112 for processing to carry out the first operation.

In act 404, the testing tool 116 detects status of the first operation based on the virtual device 112 executing the third instruction. For example, the testing tool 116 may detect that the first operation has resulted in an error or fault of the virtual device 112 (e.g., a segmentation fault), has resulted in the virtual device 112 being unresponsive, has resulted in the host 104 crashing, and/or resulted in an unexpected behavior of the host 104.

In act 406, the testing tool 116 generates an output based on the detected status. For example, the testing tool 116 may transmit a notification or alerting signal or message. In response, a modification to the VM system may occur. The modification may include, for example, halting execution of the host 104, re-coding a portion of the VM monitor 108, replacement of a physical hardware component 110 associated with the error, and/or the like.

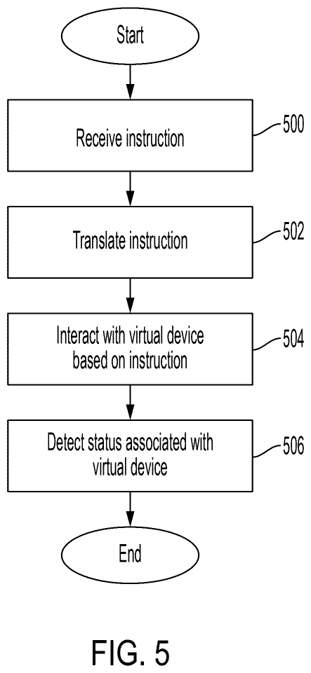

FIG. 5 depicts a flow diagram of an interaction between a VM 102 and the VM monitor 108 based on the VM executing a fuzzy testing code according to one or more embodiments. In act 500, the VM monitor 108 receives an instruction including an opcode (e.g., opcode 302) and one or more operands (e.g., the first and/or second operands 304, 306). The instruction may be implemented in machine-readable code.

The ISA emulator 114 receives the instruction and determines, based on the opcode and operands in the instruction, second instructions to be transmitted to the virtual device 112 for carrying out the operation associated with the opcode. In this regard, the ISA emulator 114 translates, in act 520, the received instruction into the second instructions that the virtual device is configured to process. In some embodiments, the second instructions include a query for the virtual device 112. In this regard, an error in the ISA emulator 114 may transmit an erroneous query to the virtual device 112 or fail to transmit the query.

In act 504, the ISA emulator 114 interacts with the virtual device based on the second instructions. In this regard, the ISA emulator 114 may receive a response from the virtual device 112 for the transmitted query. The ISA emulator 114 may package the response and transmit the response to the VM 102 as a response to the transmitted request.

If, however, an error occurs in the processing of the query by the virtual device 112, or if due to an error of the ISA emulator 114 an erroneous query is transmitted to the virtual device (or not transmitted at all), no response may be received from the virtual device. In other situations, a fault or error signal may be received.

In act 506, the VM 102 determines a status of the virtual device 112 based on the received response (or lack or response). In some embodiments, the status may be provided to the testing tool 116 for determining the outcome of the fuzzy testing.

As a person of skill in the art should appreciate, embodiments of the present disclosure allow the testing of various virtual devices 112 along with the testing of the ISA emulator 114 by injecting a fuzz input into a specified memory range, where the fuzz input is provided as an operand of an instruction that is translated by the ISA emulator 114. The testing of the virtual devices 112 and the ISA emulator 114 via a generated instruction helps provide improvements to the technical field of VM system testing. For example, less compute resources may need to be used by testing the virtual devices 112 together with the testing of the ISA emulator 114, rather than testing each in a separate process or step. In addition, the testing may be performed without analyzing source code (e.g., VM source code) and need not be restricted to testing a particular type of virtual device. In addition, the testing tool 116 need not be limited to a particular type of VM system but may be portable to other environments (e.g., other types of hypervisors) for which ISA data is available (e.g., publicly available).

In some embodiments, the testing tool 116 may be used in a pre-silicon simulation prior to manufacturing of the corresponding hardware component. For example, interaction with a hardware component may be emulated using the testing instructions to test for errors in the hardware component. Catching errors prior to manufacturing of the hardware component may result in a more efficient and less costly manufacturing process.

One or more embodiments of the present disclosure may be implemented in one or more processors. The term processor may refer to one or more processors and/or one or more processing cores. The one or more processors may be hosted in a single device or distributed over multiple devices (e.g. over a cloud system). A processor may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processor, as used herein, each function is performed either by hardware configured, i.e., hard-wired, to perform that function, or by more general-purpose hardware, such as a CPU, configured to execute instructions stored in a non-transitory storage medium (e.g. memory). A processor may be fabricated on a single printed circuit board (PCB) or distributed over several interconnected PCBs. A processor may contain other processing circuits; for example, a processing circuit may include two processing circuits, an FPGA and a CPU, interconnected on a PCB.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed herein could be termed a second element, component, region, layer or section, without departing from the spirit and scope of the inventive concept.

The terminology used herein is for the purpose of describing particular embodiments only and is not intended to be limiting of the inventive concept. Also, unless explicitly stated, the embodiments described herein are not mutually exclusive. Aspects of the embodiments described herein may be combined in some implementations.

As used herein, the terms “substantially,” “about,” and similar terms are used as terms of approximation and not as terms of degree, and are intended to account for the inherent deviations in measured or calculated values that would be recognized by those of ordinary skill in the art.

As used herein, the singular forms “a” and “an” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present disclosure”. Also, the term “exemplary” is intended to refer to an example or illustration. As used herein, the terms “use,” “using,” and “used” may be considered synonymous with the terms “utilize,” “utilizing,” and “utilized,” respectively.

Although exemplary embodiments of systems and methods for testing virtual machine systems for errors have been specifically described and illustrated herein, many modifications and variations will be apparent to those skilled in the art. Accordingly, it is to be understood that systems and methods for testing virtual machine systems for errors constructed according to principles of this disclosure may be embodied other than as specifically described herein. The disclosure is also defined in the following claims, and equivalents thereof.

The systems and methods for testing virtual machine systems for errors may contain one or more combination of features set forth in the below statements.

Statement 1. A system comprising: a processor; and a memory, wherein the memory includes first instructions that, when executed by the processor, cause the processor to: receive a command to perform a test, wherein the command includes a memory range associated with a virtual device accessible by a virtual machine; based on the command, generate a second instruction, wherein the second instruction identifies a first operation and a memory address selected from the memory range; detect status of the first operation based on the virtual device performing the first operation; and generate an output based on the status.

Statement 2. The system of Statement 1, wherein the instructions that cause the processor to detect status of the first operation include instructions that cause the processor to detect an error in processing the first operation.

Statement 3. The system of Statement 1, wherein the first instructions further cause the processor to: generate a file including the second instruction; generate machine-readable code based on the file; provide the machine-readable code to the virtual machine, wherein the virtual machine is configured to transmit the second instruction based on executing the machine-readable code.

Statement 4. The system of Statement 1, wherein the first operation includes a memory access operation.

Statement 5. The system of Statement 1, wherein the second instruction includes a value, wherein the first instructions cause the processor to generate the value.

Statement 6. The system of Statement 1, wherein the first instructions cause the processor to select the first operation from a list of operations identified by the processor.

Statement 7. The system of Statement 6, wherein the first instructions cause the processor to randomly select the first operation from the list of operations.

Statement 8. The system of Statement 6, wherein the first instructions cause the processor to: identify a profile associated with the list of operations; and select the first operation based on the profile.

Statement 9. The system of Statement 6, wherein the first instructions cause the processor to: identify a frequency of performing the first operation; and select the first operation based on the frequency.

Statement 10. The system of Statement 9, wherein the frequency of performing the first operation is less than a frequency of performing a second operation of the list of operations.

Statement 11. A method comprising: receiving, by a processor, a command to perform a test, wherein the command includes a memory range associated with a virtual device accessible by a virtual machine; based on the command, generating, by the processor, an instruction, wherein the instruction identifies a first operation and a memory address selected from the memory range; detecting, by the processor, status of the first operation based on the virtual device performing the first operation; and generating, by the processor, an output based on the status.

Statement 12. The method of Statement 11, wherein the detecting of the status of the first operation include detecting an error in processing the first operation.

Statement 13. The method of Statement 11 further comprising: generating, by the processor, a file including the instruction; generating, by the processor, a machine-readable code based on the file; providing, by the processor, the machine-readable code to the virtual machine, wherein the virtual machine transmits the instruction based on executing the machine-readable code.

Statement 14. The method of Statement 11, wherein the first operation includes a memory access operation.

Statement 15. The method of Statement 11, wherein the instruction includes a value, wherein the processor generates the value.

Statement 16. The method of Statement 11 further comprising selecting the first operation from a list of operations identified by the processor.

Statement 17. The method of Statement 16 further comprising randomly selecting the first operation by the processor from the list of operations.

Statement 18. The method of Statement 16 further comprising: identifying a profile associated with the list of operations; and selecting the first operation based on the profile.

Statement 19. The method of Statement 16 further comprising: identifying, by the processor, a frequency of performing the first operation; and selecting, by the processor, the first operation based on the frequency.

Statement 20. The method of Statement 19, wherein the frequency of performing the first operation is less than a frequency of performing a second operation of the list of operations.

What is claimed is:

1. A system comprising:
a processor; and
a memory, wherein the memory includes first instructions that, when executed by the processor, cause the processor to:
receive a command to perform a test, wherein the command includes a memory range associated with a virtual device accessible by a virtual machine;
based on the command, generate a second instruction, wherein the second instruction identifies a first operation and a memory address selected from the memory range;
detect status of the first operation based on the virtual device performing the first operation; and
generate an output based on the status.

2. The system of claim 1, wherein the instructions that cause the processor to detect status of the first operation include instructions that cause the processor to detect an error in processing the first operation.

3. The system of claim 1, wherein the first instructions further cause the processor to:
generate a file including the second instruction;
generate machine-readable code based on the file;
provide the machine-readable code to the virtual machine, wherein the virtual machine is configured to transmit the second instruction based on executing the machine-readable code.

4. The system of claim 1, wherein the first operation includes a memory access operation.

5. The system of claim 1, wherein the second instruction includes a value, wherein the first instructions cause the processor to generate the value.

6. The system of claim 1, wherein the first instructions cause the processor to select the first operation from a list of operations identified by the processor.

7. The system of claim 6, wherein the first instructions cause the processor to randomly select the first operation from the list of operations.

8. The system of claim 6, wherein the first instructions cause the processor to:
identify a profile associated with the list of operations; and
select the first operation based on the profile.

9. The system of claim 6, wherein the first instructions cause the processor to:
identify a frequency of performing the first operation; and
select the first operation based on the frequency.

10. The system of claim 9, wherein the frequency of performing the first operation is less than a frequency of performing a second operation of the list of operations.

11. A method comprising:
receiving, by a processor, a command to perform a test, wherein the command includes a memory range associated with a virtual device accessible by a virtual machine;
based on the command, generating, by the processor, an instruction, wherein the instruction identifies a first operation and a memory address selected from the memory range;
detecting, by the processor, status of the first operation based on the virtual device performing the first operation; and
generating, by the processor, an output based on the status.

12. The method of claim 11, wherein the detecting of the status of the first operation include detecting an error in processing the first operation.

13. The method of claim 11 further comprising:
generating, by the processor, a file including the instruction;
generating, by the processor, a machine-readable code based on the file;
providing, by the processor, the machine-readable code to the virtual machine, wherein the virtual machine transmits the instruction based on executing the machine-readable code.

14. The method of claim 11, wherein the first operation includes a memory access operation.

15. The method of claim 11, wherein the instruction includes a value, wherein the processor generates the value.

16. The method of claim 11 further comprising selecting the first operation from a list of operations identified by the processor.

17. The method of claim 16 further comprising randomly selecting the first operation by the processor from the list of operations.

18. The method of claim 16 further comprising:
identifying a profile associated with the list of operations; and
selecting the first operation based on the profile.

19. The method of claim 16 further comprising:
identifying, by the processor, a frequency of performing the first operation; and
selecting, by the processor, the first operation based on the frequency.

20. The method of claim 19, wherein the frequency of performing the first operation is less than a frequency of performing a second operation of the list of operations.
